(19) United States
(12) Patent Application Publication
(10) Pub. No.: US 2009/0205946 A1
(43) Pub. Date: Aug. 20, 2009

(54) Integrated Compressor/Stripper Configurations And Methods

(75) Inventors: Satish Reddy, Irvine, CA (US); John Gillmartin, Aliso Viejo, CA (US); Valerie Francuz, Rancho Santa Margarita, CA (US)

Correspondence Address: FISH & ASSOCIATES, PC;ROBERT D. FISH, 2603 Main Street, Suite 1000, Irvine, CA, 92614-6232, US

(73) Assignee: FLUOR TECHNOLOGIES CORPORATION, Aliso Viejo, CA (US)

(21) Appl. No.: 12/095,788

(22) PCT Filed: Dec. 14, 2006
(86) PCT No.: PCT/US2006/048014

§ 371 Date: Sep. 9, 2008

Related U.S. Application Data
(60) Provisional application No. 60/752,693, filed on Dec. 19, 2005.

(51) Int. Cl. B01D 3/42; B01D 3/14

(52) U.S. Cl. 203/75; 202/158

(57) ABSTRACT

Contemplated solvent regenerators include a flash drum in which lean solvent from the regenerator is flashed, and from which supplemental steam is recovered that is then fed back to the regenerator using a compressor, and most preferably a thermocompressor. Such devices have a substantially reduced net steam and energy requirement despite an increase in electrical energy demand, and further maintain a neutral water balance in the regenerator.

This application claims priority to our copending U.S. provisional patent application with the Ser. No. 60/752693, which was filed Dec. 19, 2005.

### FIELD OF THE INVENTION

The field of the invention is configurations and methods of solvent regeneration using a stripping medium.

### BACKGROUND OF THE INVENTION

Acid gas removal using a lean solvent is common practice in numerous plants, and the absorbed acid gas is in many cases expelled from the rich solvent in a stripper using a suitable stripping medium. For example, carbon dioxide can be removed from flue gas using amine-based solvents (e.g., Econamine FG^{SM} and Econamine FG Plus^{SM}), which is stripped from the rich solvent using steam. Exemplary configurations for such processes are disclosed in U.S. Pat. Nos. 3,144,301 or 4,708,721.

To improve efficiency and/or economics, a secondary regenerator may be used as described in U.S. Pat. No. 3,962,404. Alternatively, an auxiliary stripper with single steam feed may be implemented where steam is flashed from the process as described in U.S. Pat. No. 4,035,166. However, such processes are often relatively expensive to build and operate as more equipment is needed, and in at least some cases, increased solvent flow and pumping is required.

In other known configurations of acid gas removal from feed gases, valuable vapors are flashed from the rich solvent prior to solvent regeneration in a downstream column as described, for example, in U.S. Pat. Nos. 5,325,672, 5,406,802, 5,462,583, and 5,551,972. Similarly, U.S. Pat. No. 5,321,952 and WO 2004/080573A1 teach use of a multi-pressure stripper in which vapors from each stage are compressed and fed to a stage upstream to thus reduce heating requirements. While such configurations will typically improve the separation efficiency and other parameters of a gas treatment plant, the absorber pressure is often significantly above regenerator/flash pressure. Therefore, the cost of recompression in such configurations is economical only justified under limited circumstances.

In still further known systems, at least some of the steam is recovered from the flashed lean solvent as described in U.S. Pat. Nos. 2,886,405, 3,217,466, and 3,823,222 to assist with stripping in the column. In such systems, the recovered steam is injected back into the column using motive steam that may be advantageously produced from the feed gas using heat generated in the plant (e.g., by using raw water-saturated syngas and the heat of the syngas). While such configurations may provide some benefits where feed gas has a relatively high temperature and is saturated with water, various disadvantages nevertheless remain. Most significantly, the water introduced into the system by the motive steam will offset the water balance in the regeneration process. Still further, the so added water must be removed from the system, which typically increases cooling demands, and may need further treatment prior to discharge due to entrained solids or catalysts.

Thus, while numerous configurations and methods of flue gas treatment are known in the art, all or almost all of them, suffer from one or more disadvantages. Therefore, there is still a need for improved configurations and methods of flue gas treatments.

### SUMMARY OF THE INVENTION

The present invention is directed to configurations and methods of solvent recovery in which lean solvent is flashed to generate flashed steam, which is compressed and fed back to the stripping column. Most preferably, stripping steam for the stripping column is recycled between the column and a heat source, and the flashed steam is reintroduced to the column without addition of further steam. Therefore, it should be recognized that the water balance of the stripping column remains unaltered and condensate removal and/or control issues are avoided.

In one aspect of the inventive subject matter, a method of regenerating a solvent comprises a step of forming a lean solvent from a rich solvent in a stripping column using a first steam feed and a second steam feed. In another step, the lean solvent is flashed to thereby generate the first steam feed and a flashed lean solvent, and the first steam feed is introduced to the stripping column via a compressor, while the second steam feed is recycled between the stripping column and a heat source.

Typically, the rich solvent has a pressure of between 20 psia and 40 psia, the lean solvent is flashed to a pressure of between 2 psia and 20 psia, and the second steam feed is saturated steam at 50 psig. In preferred aspects, the compressor is a thermocompressor or a steam turbine compressor, the feed gas is a flue gas, and the solvent is an amine solvent.

In another aspect of the inventive subject matter, a method of upgrading an existing stripping column in which a steam circuit provides steam for stripping and in which the steam is generated by a reboiler includes a step of fluidly coupling a flash vessel to an existing stripping column such that lean solvent from the stripping column is flashed to thereby produce flashed steam and a flashed lean solvent. In another step, a compressor is fluidly coupled to the flash vessel and stripping column such that the flashed steam is fed into the stripping column without additional water introduction.

Therefore, contemplated solvent regeneration system will comprise a stripping column fluidly coupled to a flash drum that is configured to receive lean solvent from the stripping column at a pressure differential effective to release steam from the flashed lean solvent, and will further comprise a compressor (e.g., thermocompressor or a steam turbine compressor) fluidly coupled to the flash drum and configured to introduce the steam from the flash drum into the regenerator without additional introduction of water. Where desirable, contemplated plants will further include a steam circuit configured to provide steam condensate from the stripping column to a heat source and to provide steam from the heat source to the stripping column.

Preferably, the stripping column is configured to operate at a pressure of between 20 psia and 40 psia, and the flash drum is configured to flash the lean solvent to a pressure of between 2 psia and 20 psia. While contemplated plants may be constructed as a grassroots installation, the flash drum and compressor may also be provided as a retrofit to the stripping column. Contemplated plants will further typically include an absorber fluidly coupled to the stripping column, wherein the absorber is configured to receive a feed gas (e.g., flue gas) and to provide a rich solvent to the stripping column.

Various objects, features, aspects and advantages of the present invention will become more apparent from the following detailed description of preferred embodiments of the invention

### BRIEF DESCRIPTION OF THE DRAWING

FIG. 1 is an exemplary configuration comprising a stripping column with integrated steam regeneration via flash drum and thermocompressor.

### DETAILED DESCRIPTION

The inventors have unexpectedly discovered that certain operational parameters and economics of various stripping processes can be significantly improved by flashing the lean solvent to a lower pressure to thereby generate stripping vapor which is then re-introduced into the stripping column. In especially preferred aspects, the reintroduction of the stripped steam is performed without motive steam (e.g., via a compressor, and most preferably via thermocompressor) and the stripping column is operated with a steam circuit in which steam is recycled between the column and an external heat source. Thus, it should be appreciated that such configurations maintain the water balance in the stripping column while reducing energy and material requirements for steam generation and cooling. Still further, waste water treatment from excess water otherwise introduced (e.g., via motive steam in an ejector or via water-saturated rich solvent) is avoided and water is conserved as a resource.

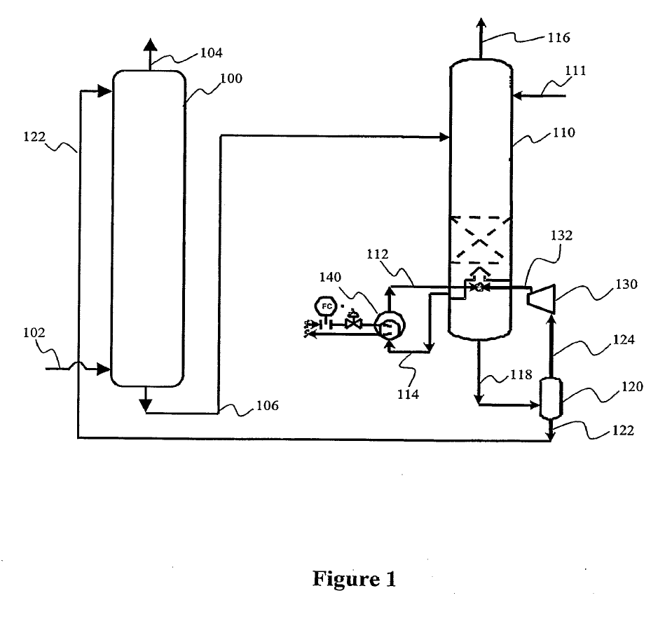

In one especially preferred aspect as depicted in FIG. 1, a plant includes an absorber 100 that receives a feed gas 102 and lean solvent 122 from flash drum 120 via a pump (not shown). The absorber 100 produces purified gas 104 and rich solvent 106, which is routed to the striping column 110. The rich solvent (e.g. CO₂-rich Econamine FG Plus^{SM} solvent) is then processed in the stripping column 110 using steam 112 that is formed from water 114 (e.g., using reboiler 140), which is drawn from the bottom of the column 110. Acid gas 116 is routed to an appropriate downstream unit (e.g., liquefaction, EOR, sequestration, etc.) pressurized hot lean solvent 118 (e.g., 26.6 psia) is discharged at or near the bottom of the stripping column 110. The lean solvent 118 is subsequently fed to a flash drum 120 and flashed to lower pressure (e.g., 14.7 psia). The resulting flashed vapor 124 predominantly comprises steam with small amounts of carbon dioxide and solvent. The flashed vapor 124 is then compressed by a compressor 130 and returned to the bottom of the stripping column 110 as stream 132 where it flows upward through the column while removing carbon dioxide from the rich solvent. Preferably, stripping column 110 is refluxed with stream 111 to avoid loss of water or other stripping medium (reflux condenser, pumps, and associated equipment not shown).

Remarkably, despite the additional energy requirement for vapor re-compression of the flashed steam to the pressure for the stripping column, the net energy need is decreased. Moreover, cooling water consumption in such configurations is also reduced. An exemplary performance summary is shown in Table 1 below, reflecting the results of two simulations in which a standard stripping column was used as base case, and in which the comparative case included an additional flash tank and thermocompressor as depicted in FIG. 1. Remaining design parameters (e.g., lean loading, feed conditions and composition [CO₂ content of 3.9 mol %], cooling water conditions, and carbon dioxide capture rate) were unchanged between the two simulations, and the results in Table 1 are expressed relative to the base case. Steam and electrical power cost were based on $14/Gcal and $0.034/kWh, respectively, and it was assumed that reboiler steam was saturated steam at 3.5 kg/cm²(g) (50 psig).

TABLE 1
PERFORMANCE SUMMARY

| PARAMETER | THERMO-COMPRESSOR |
|---|---|
| Electrical Power Required | 13% Increase relative to Base |
| Cooling Water Required | 16% Decrease relative to Base |
| Steam + Power Cost | 5% Decrease relative to Base |
| Reboiler Steam | 11% Decrease relative to Base |
| Stripper Diameter | 6% Increase relative to Base |

Based on these and various other considerations (not shown), it should be appreciated that contemplated configurations and methods may decrease the steam requirement relative to a conventional plant by about 11%. Furthermore, it should be recognized that the cooling water requirement of such plants decreases by approximately 16%. While the electrical power requirement increases by about 13%, it should be noted that the overall steam and electrical power operating cost decreases by 5%. In addition, the water treating plant capacity need not be increased, nor is an additional or enlarged waste water treating unit required. In contrast, where ejectors and other devices using motive fluids (typically water) are employed, the additional waster must be moved from the process which has at least two significant disadvantages. First, cooling requirements substantially increase to condense the water in the stripping column. Second, the so removed excess water must then be treated to remove carryover solvent catalyst, entrained particulate-matter, etc. as it can typically not be re-used in a plant or simply discharged into the sewer system.

While contemplated configurations and methods are particularly advantageous-in plants using Econamine FG Plus^{SM} (e.g., capture of carbon dioxide from flue gas from combustion sources such as combined cycles, boilers, and/or ammonia plants), it should be noted that at least some of the advantages presented herein may also be achieved in other processes using other amine-based and even non-amine-based (e.g., carbonate) solvents. Consequently, the composition and pressure of suitable feed gases will vary considerably. However, it is generally preferred that the feed gas to the absorber will be at a pressure of between about 15 psia and about 50 psia, even less typically between about 25 psia and about 100 psia, or even higher (e.g., between.50 psia and 500 psia). Therefore, suitable absorbers will be configured to operate in a range of 50 psia and 500 psia, more typically 25 psia and about 100 psia, and most typically between about 15 psia and about 50 psia.

Similarly, with respect to suitable temperatures of contemplated feed gases, it is preferred that the temperature is between about 20° C. and about 600° C. (in rare cases even higher), more typically between about 50° C. and about 400° C., and most typically between about 100° C. and about 350° C. The water content of suitable feed gases may also vary considerably. The acid gas content of a typical feed gas will generally be in the range of about 1-20 vol %, and most typically between about 2-10 vol % (predominantly comprising at least one of CO₂ and H₂S). Especially suitable feed gases will therefore include combustion gases from boilers, turbines, ammonia plants, etc., but also gases with significant hydrogen content (e.g., >5 mol %) or those comprising a valuable hydrocarbon component (e.g., natural gas).

In most contemplated aspects of the inventive subject matter, the stripping column is operated at about the same pressure (+/−10 psi) as the absorber, and will most typically operate at a pressure of about 30 psia. However, where desired, the absorber may also operate at significantly higher pressures than the stripping column (e.g., more than 10 psia, more typically more than 50 psia, most typically more than 100 psia). Therefore, an intermediate pressure reduction device (e.g., expansion turbine to generate electricity) may be included to reduce the pressure of the rich solvent prior to entry into the stripping column. On the other hand, and where desired, a pump may be included to increase the pressure of the rich solvent in the stripping column (which may increase the steam yield after flashing). The stripping column is preferably configured such that the stripping medium is recycled between the column (e.g., via condensation in an integrated or overhead condenser) and a heat source (e.g., steam heated reboiler) to thereby provide the stripping steam to the process: It should be noted that in such configurations, no net addition of water to the column is achieved, and that the water balance in the stripping process is maintained in a simple and effective manner.

With respect to the flash vessel, it should be appreciated that numerous flash vessels are known in the art and all of them are deemed suitable for use herein so long as such flash vessels allow withdrawal of flashed steam from the lean solvent that is provided to the flash vessel from the stripping column. Flash vessels are typically operated at any positive pressure differential that will generate at least some steam from the flashing step. Therefore, suitable pressure differentials will, for example, be between 1 psi and 10 psi, and more preferably between 5 and 25 psi (or even between 25 psi to 100 psi, and higher). Furthermore, it is generally preferred that the flash vessel will be operated at a pressure at or near atmospheric pressure.

Flashed steam from the flash vessel is then preferably directly routed to a compressor that compresses the steam to a pressure suitable for feeding the compressed steam into the stripping column. Therefore, the type of compressor may vary considerably. However, it is generally preferred that steam compression is performed using a thermocompressor or steam turbine driven compressor. Alternative manners of compression are also deemed suitable so long as such manners will not introduce additional quantities of water to the stripping column (e.g., steam ejector is not deemed suitable, unless the motive steam is provided by the steam circuit that is heated by the reboiler).

It should be especially appreciated that re-introduction of the steam to the stripping column not only maintains the water balance in the column, but also prevents loss of the water to the astrosphere. Moreover, alternative technologies that introduce large amounts of water into the plant (e.g., conventionally operated steam ejectors) require that such water must be rejected from the plant as either an undesirable solvent tainted liquid or as vapor in the absorber vent. While such rejection would avoid the cost of treating of the waste water for discharge, increased water content in the vent also increases the solvent emissions from the plant. In addition, the additional water utilized for the steam ejector must be supplied by a water treating plant thus increasing the capacity of the unit.

Thus, specific embodiments and applications of compressor-stripper combinations have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A method of regenerating a solvent in a process in which a feed gas comprising an acid gas is contacted with a lean solvent to thereby generate a rich solvent and a processed feed gas, comprising:
forming a lean solvent from a rich solvent in a stripping column using a first steam feed and a second steam feed;
flashing the lean solvent to thereby generate the first steam feed and a flashed lean solvent, wherein the first steam feed is introduced to the stripping column via a compressor; and
wherein the second steam feed is recycled between the stripping column and a heat source.

2. The method of claim 1 wherein the rich solvent has a pressure of between 20 psia and 40 psia.

3. The method of claim 1 wherein the lean solvent is flashed to a pressure of between 2 psia and 20 psia.

4. The method of claim 1 wherein the second steam feed is saturated steam between 30 psig and 70 psig.

5. The method of claim 1 wherein the compressor is a thermocompressor or a steam turbine compressor.

6. The method of claim 1 wherein the feed gas is a flue gas and wherein the solvent is an amine solvent.

7. A method of upgrading an existing stripping column in which a steam circuit provides steam for stripping and in which the steam is generated by a reboiler, comprising:
fluidly coupling a flash vessel to an existing stripping column such that lean solvent from the stripping column is flashed to thereby produce flashed steam and a flashed lean solvent;
coupling a compressor to the flash vessel and stripping column such that the flashed steam is fed into the stripping column without additional water introduction.

8. The method of claim 7 wherein the existing stripping column is operated at a pressure of between 20 psia and 40 psia.

9. The method of claim 7 wherein the lean solvent is flashed to a pressure of between 2 psia and 20 psia.

10. The method of claim 7 wherein the compressor is a thermocompressor or a steam turbine compressor.

11. The method of claim 7 wherein the solvent comprises an amine solvent.

12. A solvent regeneration system comprising:
a stripping column fluidly coupled to a flash drum that is configured to receive lean solvent from the stripping column at a pressure differential effective to release steam from the flashed lean solvent; and
a compressor fluidly coupled to the flash drum and configured to introduce the steam from the flash drum into the regenerator without additional introduction of water.

13. The system of claim 12 further comprising a steam circuit configured to provide steam condensate from the stripping column to a heat source and to provide steam from the heat source to the stripping column.

14. The system of claim 12 wherein the stripping column is configured to operate at a pressure of between 20 psia and 40 psia.

15. The system of claim 12 wherein the flash drum is configured to flash the lean solvent to a pressure of between 2 psia and 20 psia.

16. The system of claim 12 wherein the compressor is a thermocompressor or a steam turbine compressor.

17. The system of claim 12 wherein the solvent is an amine solvent.

18. The system of claim 12 wherein the flash drum and compressor are a retrofit to the stripping column.

19. The system of claim 12 further comprising an absorber fluidly coupled to the stripping column, wherein the absorber is configured to receive a feed gas and to provide a rich solvent to the stripping column.

20. The system of claim 19 wherein the feed gas is a flue gas.
